(19) United States
(12) Patent Application Publication
(10) Pub. No.: US 2013/0293887 A1
(43) Pub. Date: Nov. 7, 2013

(54) Solution Sample Holding Method, Sample Cell, And Circular Dichroism Measuring Apparatus

(71) Applicants: Ettore Castiglioni, Lombardia (IT); Yoshiro Kondo, Tokyo (JP); Ichitaro Kohge, Hachioji-machi (JP)

(72) Inventors: Ettore Castiglioni, Lombardia (IT); Yoshiro Kondo, Tokyo (JP); Ichitaro Kohge, Hachioji-machi (JP)

(73) Assignee: JASCO CORPORATION, Tokyo (JP)

(21) Appl. No.: 13/462,856

(22) Filed: May 3, 2012

(51) Int. Cl. G01N 21/19; G01N 21/01; G01N 21/59

(52) U.S. Cl. 356/364; 356/440

(57) ABSTRACT

A solution sample holding method between two light-transmitting plate-like members for measuring light passing through a minute amount of solution sample, comprises a dripping step and a covering step. The dripping step is to drip a minute amount of solution sample in a drip area of a sample mounting face of a first light-transmitting member. The sample mounting face also includes a liquid-repellent area surrounding the drip area. The covering step is to cover the solution sample with a second light-transmitting member and to maintain a predetermined distance between the first light-transmitting member and the second light-transmitting member. The liquid-repellent area of the sample mounting face is covered with a liquid-repellent substance. The minute amount of solution sample is held in contact with the two light-transmitting members.

### BACKGROUND OF THE INVENTION

1. Field of the Invention

The present invention relates to methods of holding a minute amount of solution sample, and more specifically, to elimination of the effects of strain in a sample cell used in circular dichroism measurement on measuring accuracy, and stable measurement of a minute amount of solution sample.

2. Description of the Related Art

Substances having chirality exhibit circular dichroism (CD), that is, a difference in absorbance between right-handed and left-handed circularly polarized light. Since such circular dichroism occurs at a characteristic wavelength of the substance in question, circular dichroism is widely used to understand the three-dimensional molecular structure and the like of the substance. A fluorescence detection circular dichroism (FDCD) spectrometer measures a difference in intensity of fluorescence generated when an optically active sample is excited with right-handed and left-handed circularly polarized light.

Joined Cell

In one general method of measuring a solution sample by using a circular dichroism spectrometer, light is radiated onto the solution sample placed in a rectangular or cylindrical cell through a cell window (Unexamined Japanese Patent Application Publication No. 2001-133399). FIGS. 9A, 9B, and 9C show general sample cells. For example, to measure about 100 μl (microliters) of solution sample, a cell made of two joined glass plates, as shown in FIG. 9A, is used. The solution sample is first placed in one glass plate 91 with a concavity and then covered with another glass plate 92. Since the distance between the two glass plates is the optical path length of measurement light, the joined faces are precision polished to ensure the accuracy of the optical path length.

As described in Unexamined Japanese Patent Application Publication No. 2001-133399, since any stress applied to the glass plates will affect the accuracy of circular dichroism measurement, the two glass plates in some cells are just held in contact with each other, without using any bonding agent. Rather, the two glass plates are held just by the surface tension of the solution sample held therebetween. If any residual internal stress in the glass plates produces a strain, the polarization state of measurement light may be disturbed, causing left-handed circularly polarized light to change to right-handed circularly polarized light, for example.

In circular dichroism measurement of valuable natural extracts, proteins, and the like, the amount of sample that can be collected is often limited. The conventional joined cell, however, requires at least about 100 μl of solution sample, in order to prevent air bubbles from being formed when the plates are joined. A cell holding a minute amount of solution sample must be handled with special care because air bubbles can enter the sample while the cell is being moved.

Capillary Cell

General Optical Measurement Such as Infrared Absorption Measurement Uses Capillary cells 93 for a minute amount of solution, as shown in FIGS. 9B and 9C. The capillary cell 93 has a capillary tube made of silica glass, as shown in FIG. 9B, and a minute amount of solution sample infiltrates in the tube. The measurement light focused by an objective lens 94 is radiated to the cell, light passing through the cell is collected by a condenser lens 95, and consequently the intensity of light passing through the minute amount of solution sample held in the cell is detected.

Using the capillary cell with the circular dichroism spectrometer would cause problems with measurement accuracy. A capillary tube having a very small diameter is likely to be strained, which easily disturbs the polarization state of circularly polarized light radiated onto the cell as the measurement light. If the polarization state is changed by the cell, the baseline of the spectrum data to be detected would be distorted, which would affect the measurement accuracy of the circular dichroism spectrometer. Therefore, the capillary cell is not suitable for circular dichroism measurement.

### SUMMARY OF THE INVENTION

In view of the problems described above, it is an object of the present invention, in measuring light passing through a minute amount of solution sample by holding the solution sample between two light-transmitting plate-like members facing each other with a given distance between them,

1) to protect the light-transmitting plate-like members from strain,
2) to hold a minute amount of solution sample, ranging from several microliters to ten microliters, and
3) to prevent air bubbles from getting into the solution sample.

It is another object of the present invention to provide a sample cell that can achieve the object described above and to provide a circular dichroism measuring apparatus using the sample cell.

The inventors provided a ring-shaped fluorine coating on the surface of one glass plate of the joined cell, dripped the solution sample at the center, and found that the hydrophobic and lipophobic properties of the fluorine coating prevented the solution sample from moving and enabled the minute amount of solution sample to be held stably in the position where it was dripped. They also found that the minute amount of solution sample held in this state can be covered easily with another glass plate, keeping out air bubbles.

A solution sample holding method according to the present invention includes a dripping step of dripping a minute amount of solution sample in a drip area of a sample mounting face of a first light-transmitting member, the sample mounting face also including a liquid-repellent area surrounding the drip area, and a covering step of covering the solution sample with a second light-transmitting member and maintaining a predetermined distance between the first light-transmitting member and the second light-transmitting member.

The liquid-repellent area of the sample mounting face is covered with a liquid-repellent substance, and the minute amount of solution sample is held in contact with the two light-transmitting members. Liquid repellency is rejection of liquid, like water-repellency and oil-repellency, and includes hydrophobicity against aqueous solution samples.

A sample cell according to the present invention includes two light-transmitting plate-like members facing each other with a predetermined distance between them and holds a solution sample between the two light-transmitting members. In the sample cell, a first light-transmitting member has a sample mounting face containing a drip area where the solution sample is dripped and a liquid-repellent area surrounding the drip area, and the liquid-repellent area of the sample mounting face is covered with a liquid-repellent substance; a second light-transmitting member is kept at the predetermined distance from the first light-transmitting member and covers the solution sample dripped in the drip area of the sample mounting face; and the solution sample is held in contact with the two light-transmitting members.

It is preferable that the first light-transmitting member have indicating means for indicating, by color or shape, whether its front or back face is the sample mounting face.

A circular dichroism measuring apparatus according to the present invention includes the sample cell, polarization modulating means for periodically modulating the polarization state of light emitted from light emitting means, and detecting means for detecting light; polarization-modulated light is radiated onto the minute amount of solution sample through the second light-transmitting member of the sample cell; and light passing through the solution sample is detected by the detecting means, thereby measuring the circular dichroism of the solution sample.

According to a solution sample holding method, a sample cell, and a circular dichroism measuring apparatus of the present invention, a solution sample is held between two light-transmitting plate-like members by the surface tension of the solution sample, so that strain is not produced in the cell unlike in the conventional capillary cells, and distortion of the baseline can be suppressed.

Since a liquid-repellent substance is placed in a liquid-repellent area provided on one light-transmitting member, the solution sample dripped in a drip area is repelled by the liquid-repellent area and is forced to stay in the drip area. Since the other light-transmitting member can cover the minute amount of solution sample while the solution sample is repelled by the liquid repellency of the liquid-repellent area and is forced to remain stably in the drip area, air bubbles are kept out.

Since the solution sample is held in contact with the two light-transmitting members and is enclosed by the liquid-repellent substance, the solution sample will not move in the cell even when the sample cell is moved or placed in an upright position.

Therefore, according to the present invention, strain is unlikely to be produced in the light-transmitting plate-like members, a minute amount of solution sample, ranging from several microliters to ten microliters, can be held therebetween, and air bubbles can be kept out of the solution sample.

### BRIEF DESCRIPTION OF THE DRAWINGS

FIG. 1 shows an overall structure of a circular dichroism spectrometer of the present invention.

FIG. 2 is an exploded view of a sample cell of the present invention.

FIGS. 3A, 3B, and 3C are sectional views illustrating steps of placing a solution sample in the sample cell of the present invention.

FIGS. 4A and 4B show an exploded view and a sectional view, respectively, of a sample cell of a modification of the present invention, and FIG. 4C shows a sectional view of a sample cell of another modification.

FIG. 5 shows a perspective view illustrating indicating means formed on the sample cell.

FIG. 6 is a graph showing a baseline measured in an embodiment.

FIG. 7 is a graph showing the CD spectrum of d-10-ACS in the embodiment.

FIG. 8 is a graph showing the CD spectrum of lysozyme in the embodiment.

FIG. 9A shows a conventional joined cell, and FIGS. 9B and 9C show a conventional capillary cell.

### DESCRIPTION OF THE PREFERRED EMBODIMENTS

A circular dichroism measuring apparatus (hereafter called circular dichroism spectrometer) according to the present invention will be described below with reference to the drawings.

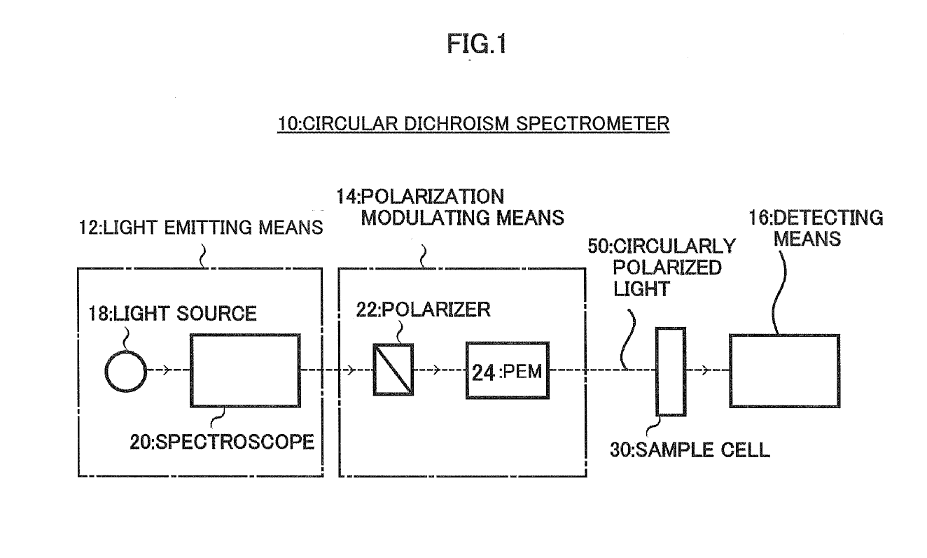

FIG. 1 shows an overall structure of a circular dichroism spectrometer 10 of an embodiment of the present invention. The circular dichroism spectrometer 10 includes light emitting means 12, polarization modulating means 14 for periodically modulating the polarization state of light radiated from the light emitting means 12, and detecting means 16 for detecting light. In the present embodiment, circularly polarized light modulated by the polarization modulating means 14 is radiated onto a sample cell 30, and light passing through the sample cell 30 is detected by the detecting means 16. For example, an integrating sphere may be provided after the sample cell 30 to detect transmitted light including diffused transmitted light.

The light emitting means 12 includes a light source 18 and a spectroscope 20. Light in the ultraviolet region or visible region emitted from the light source 18 is made into single-wavelength light by the spectroscope 20. By using a monochromator equipped with a diffraction grating as the spectroscope 20, required single-wavelength light can be selected successively, and wavelength scanning can be performed in a predetermined range.

The polarization modulating means 14 includes a polarizer 22 and a piezoelastic modulator (PEM) 24, which is a photoelastic modulator. The single-wavelength light from the spectroscope 20 is converted to linearly polarized light by the polarizer 22. The azimuth angle of the PEM 24 is displaced from the azimuth angle of the polarizer 22 by a given angle (such as 45°) around the optical axis. When the linearly polarized light from the polarizer 22 passes through the PEM 24, a phase difference is given between the polarized components in independent directions, and the polarization state of the linearly polarized light is modulated periodically. That is, the linearly polarized light is converted to right-handed and left-handed circularly polarized light cyclically. The PEM 24 is supplied with a driving voltage of a predetermined frequency (50 kHz, for example), and the right-handed and left-handed circularly polarized light is radiated onto the sample cell 30 in accordance with the frequency.

The circularly polarized light modulated by the PEM 24 is radiated onto the sample cell 30 and passes through the solution sample S in the sample cell 30. The transmitted light is detected by the detecting means 16, which is a photomultiplier (PMT). On the basis of the detected signal, the circular dichroism of the solution sample S is measured. A circular dichroism (CD) spectrum is calculated from the detected signal in the conventional method. The circular dichroism is obtained by using a frequency component of the detected signal having the same frequency as the modulation frequency of the PEM 24, and a CD spectrum is obtained by wavelength scanning of the circularly polarized light radiated onto the solution sample in the spectroscope 20.

Sample Cell

A microdisc cell that can hold a minute amount of solution sample S stably is used as the sample cell 30 in the embodiment.

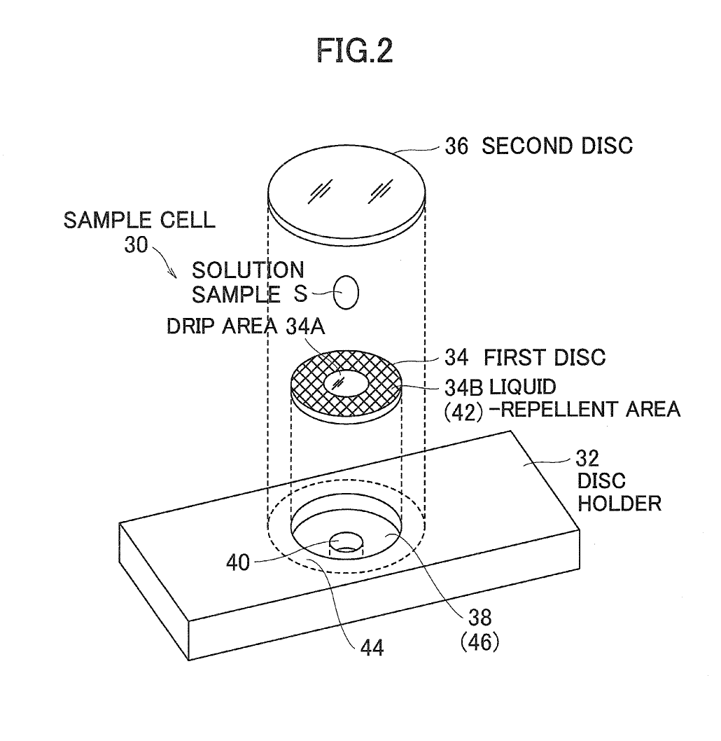

FIG. 2 is an exploded view of the sample cell 30. The sample cell 30 includes a disc holder 32 as holding means and two light-transmitting discs 34 and 36. A minute amount of solution sample S is held between the discs.

The disc holder 32 has a cylindrical concavity 38 which stores a first disc 34, and the concavity 38 has a circular bottom surface 46 having almost the same size as the first disc 34. The bottom surface 46 has a through-hole 40 penetrating the disc holder 32 roughly at its center. The bottom surface 46 is a precision polished face on which the first disc 34 is placed.

The first disc 34 is made of silica glass and has a ring-shaped fluorine coating 42 on one face. This face, which is a sample mounting face in the present invention, has an area 34B where the fluorine coating 42 is formed and a center area 34A enclosed by the area 34B. In the present invention, the area 34B corresponds to a liquid-repellent area, and the center area 34A corresponds to a drip area. The fluorine coating 42 has water-repellency and oil-repellency and may be provided on both faces of the first disc 34. It is preferable not to provide a fluorine coating on the face to be in contact with the bottom surface 46 of the disc holder 32 in order to provide the flatness of the face with high precision.

In the present invention, a different hydrophobic or lipophobic coating may be used instead of the fluorine coating. Any material that repels at least the solution sample should be used. The liquid-repellent area 34B may be formed not by using a liquid-repellent substance but by forming microasperities. Microasperities increase the surface area of the liquid-repellent area 34B, producing liquid-repellency.

A second disc 36 is made of silica glass and is large enough to cover the entire concavity 38, where the first disc 34 is placed. The periphery of the concavity 38 on the surface of the disc holder 32 is a precision polished face 44, where the second disc 36 is joined with the disc holder 32.

Usage of Sample Cell

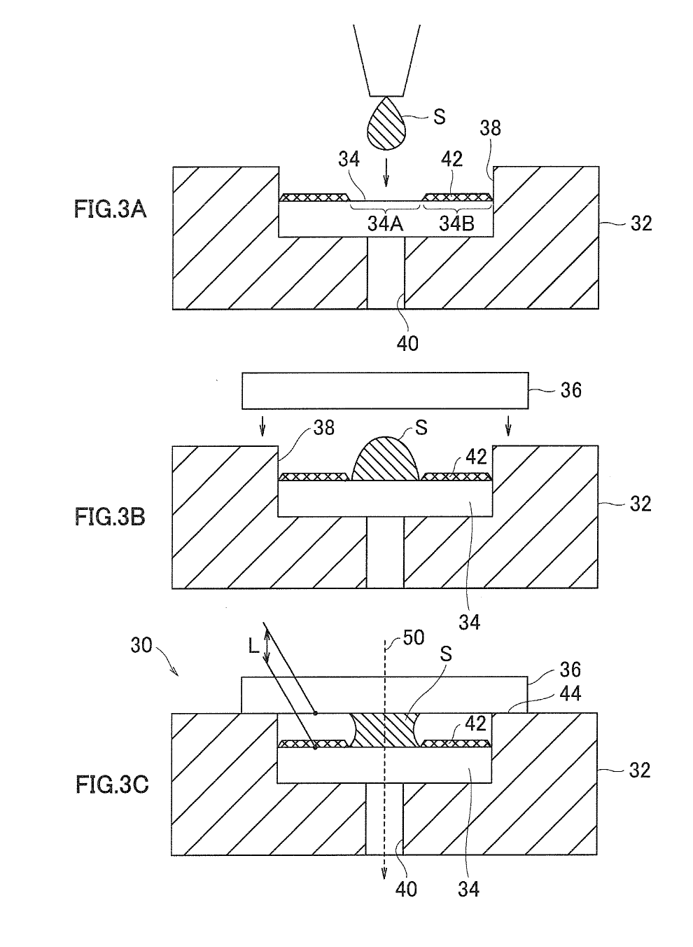

FIGS. 3A, 3B, and 3C illustrate a procedure for holding a minute amount of solution sample S, ranging from a few microliters to ten microliters, in the sample cell 30.

In FIG. 3A, the first disc 34 is placed in the concavity 38 of the disc holder 32, with the face having the fluorine coating 42 facing upward. A required amount of the solution sample S is dripped into the drip area 34A with a pipette or the like. Just a single drop may be placed. This is called a dripping step (step 1).

The fluorine coating 42 repels the dripped solution sample S, keeping it in the drip area 34A. The solution sample S receives restriction of movement. The solution sample S is kept in the drip area 34A so as not to come outside, by the liquid repellency of the liquid-repellent area 34B and is held as shown in FIG. 3B.

In FIG. 3B, the concavity 38 is covered with the second disc 36. Since the depth of the concavity 38 is greater than the thickness of the first disc 34, a space is left between the two discs. By changing the thickness of the first disc 34, the optical path length L can be specified based on the space. When the concavity 38 is covered with the second disc 36, the minute amount of solution sample S comes into contact with the inner surface of the second disc 36 and becomes as shown in FIG. 3C. The minute amount of solution sample S is held between the two discs. This step is called a covering step (step 2).

As shown in FIG. 3C, the solution sample S and air are held between the two discs. However, because the solution sample S is gathered into the drip area 34A by the fluorine coating 42, the concavity 38 can be covered with the second disc 36 in the covering step (step 2) while air is not taken into the solution sample S, preventing air bubbles from being generated.

The sample cell 30 is also called a drop measurement cell because a drop of the solution sample S is placed in the cell. The cell differs from the conventional joined cell in that the fluorine coating 42 is provided on the first disc 34, so that hardly any air bubbles are formed even if a minute amount of solution sample S is provided. It is preferable to specify the space between the two discs, namely, the optical path length L, in a range of 0.1 millimeters to a few millimeters. A range of 0.1 to 1 mm is more preferable. By adjusting the space between the discs by changing the thickness of the first disc 34, about 0.2 to 10 μl of the solution sample S can be held stably.

Circular Dichroism Measuring Method

In circular dichroism measurement, as shown in FIG. 3C, circularly polarized light 50 from the PEM 24 is incident at a right angle on the outer surface of the second disc 36. An incident angle of 90 degrees is good for maintaining the polarization state of the circularly polarized light 50. The circularly polarized light passes through the solution sample S and the drip area 34A of the first disc 34, exits from the through-hole 40 of the disc holder 32, and is detected by the detecting means 16.

As shown in FIG. 1, the sample cell 30 can be placed upright in the circular dichroism spectrometer 10. The second disc 36 of the sample cell 30 is kept on the disc holder 32 by the surface tension of the solution sample S. Even if the sample cell 30 is moved or its orientation is changed, the second disc 36 will not come off, and the solution sample S can be held stably.

By using the sample cell 30 of the present embodiment in circular dichroism measurement, about 0.2 to 10 μl of solution sample S can be held stably. This means that it becomes possible to measure valuable natural extracts, proteins, and such other substances for which an adequate amount of solution sample is conventionally difficult to obtain. Since the silica-glass discs 34 and 36 are held by the disc holder 32 and do not receive unwanted external force, the cell is unlikely to be strained, and distortion of the baseline can be suppressed, in comparison with the conventional capillary cell.

Instead of the liquid-repellent area 34B formed around the entirety of the drip area 34A, a liquid-repellent area divided into a plurality of parts and dispersed around the drip area 34A may be used. For example, the drip area 34A may be surrounded alternately by fluorine coatings 42 and parts subjected to other kinds of surface treatment.

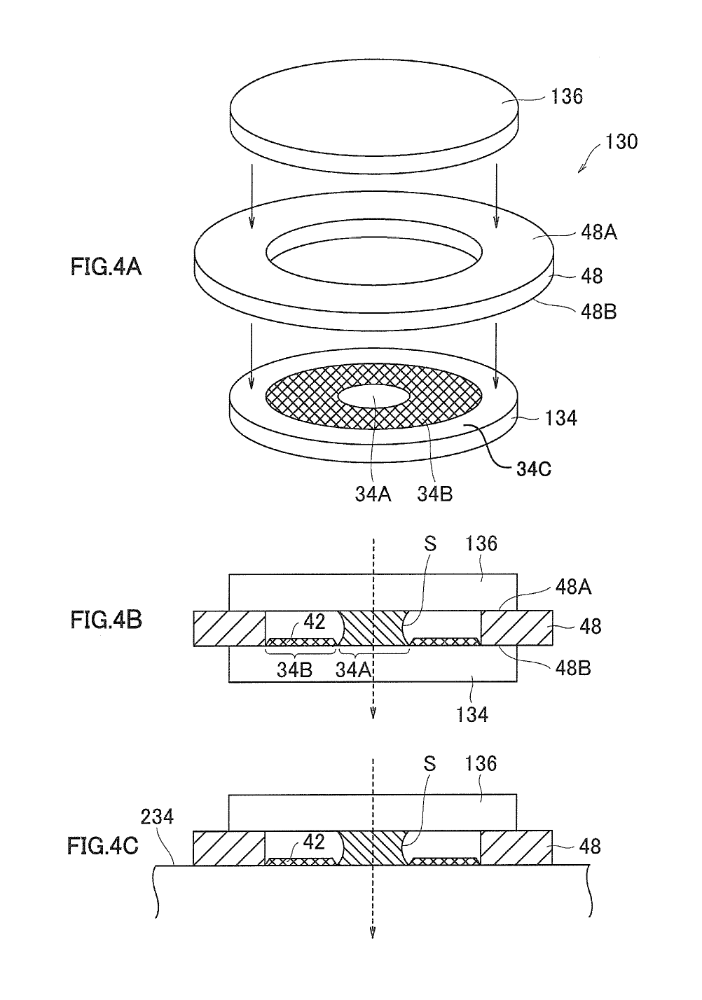

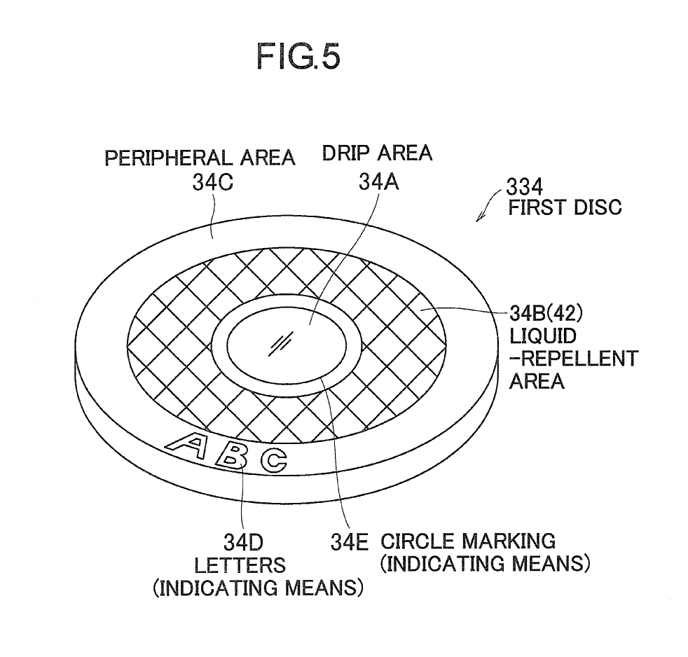

In a modification of the embodiment, a sample cell 130 uses an adjuster 48 for adjusting the optical path length L between two discs 134 and 136. The sample cell 130 will be described with reference to FIGS. 4A and 4B. As the exploded view in FIG. 4A shows, the sample cell 130 has the adjuster 48, which is an annular plate, between the discs 134 and 136. The first disc 134 differs from the first disc 34 described earlier just in that a peripheral area 34C without the fluorine coating 42 is provided outside the liquid-repellent area 34B. The second disc 136 is the same as the second disc 36 described earlier.

Since the two discs 134 and 136 are joined with the two faces 48A and 48B of the adjuster 48, the faces are precision polished to set the thickness of the adjuster 48 to the optical path length L. The sectional view in FIG. 4B shows that a minute amount of solution sample S is held between the discs 134 and 136, which are in contact with both faces of the adjuster 48.

As shown in the figure, the annular part of the adjuster 48 has an inner diameter such that the liquid-repellent area 34B of the first disc 134 fits therein. Since the thickness of the adjuster 48 equals the optical path length L, it is preferable that a plurality of adjusters 48 differing in thickness be provided in advance, and a suitable one be selected in accordance with the desired optical path length L. Since the inner faces of the two discs 134 and 136 are in contact with the solution sample S, the two discs are joined with the adjuster 48 by the surface tension of the solution sample S.

With the annular plate adjuster 48, a minute amount of solution sample S can be held as in another modification shown in FIG. 4C. In the figure, the ring-shaped fluorine coating 42 is provided on the surface of a light-transmitting sample mounting stage 234. After the solution sample S is dripped thereon, the second disc 136 is placed on the adjuster 48.

The front and back faces of the first disc of the embodiment can be differentiated easily as described below with reference to FIG. 5.

The perspective view in FIG. 5 shows a first disc 334 having indicating means such as letters, marks, and colors. Since the fluorine coating 42 is transparent, it can be difficult to see which face of the small first disc 334 has the fluorine coating 42. The first disc 334 shown in FIG. 5 has a peripheral area 34C without a fluorine coating outside the liquid-repellent area 34B, and the peripheral area 34C has desired letters 34D engraved by a laser or the like. The drip area 34A is also indicated by a circular marking 34E engraved in the same way. Since the front face of the first disc 334 is engraved by a laser or the like, the measurer can easily recognize grooves or difference in level of the letters 34D or the marking 34E, allowing him or her to easily distinguish the front face from the back face of the first disc 334. The circle marking 34E also indicates the drip position in the dripping step (step 1), making it possible to place a drop in the right position.

Microasperities may also be formed on the surface of the peripheral area 34C to provide an optical interference surface such as a diffraction grating. With colors (moiré pattern) produced by the optical interference surface, the front face of the first disc 334 can be easily distinguished from the back face. What is required on the first disc 334 is at least one of the indicating means, letters, markings, and colors. It is preferable that the indicating means be provided on the same face of the first disc 334 on which the fluorine coating 42 is provided.

The sample cell of the present embodiment can be applied to fluorescence detection circular dichroism (FDCD) spectrometers.

### EXAMPLES

Circular dichroism measurement of an actual solution sample S by using the circular dichroism spectrometer 10 and sample cell 30 of the present invention will be described next.

First, just a solvent was placed in the sample cell 30, and the baseline of the CD spectrum was measured. In the baseline measurement, the measuring apparatus configured as shown in FIG. 1 was used to radiate circularly polarized light onto the solvent and to detect transmitted light. The main measuring conditions were as follows:
Amount of solvent: 10 μl
Cell length (optical path length L): 1.0 mm
Measuring temperature: Room temperature

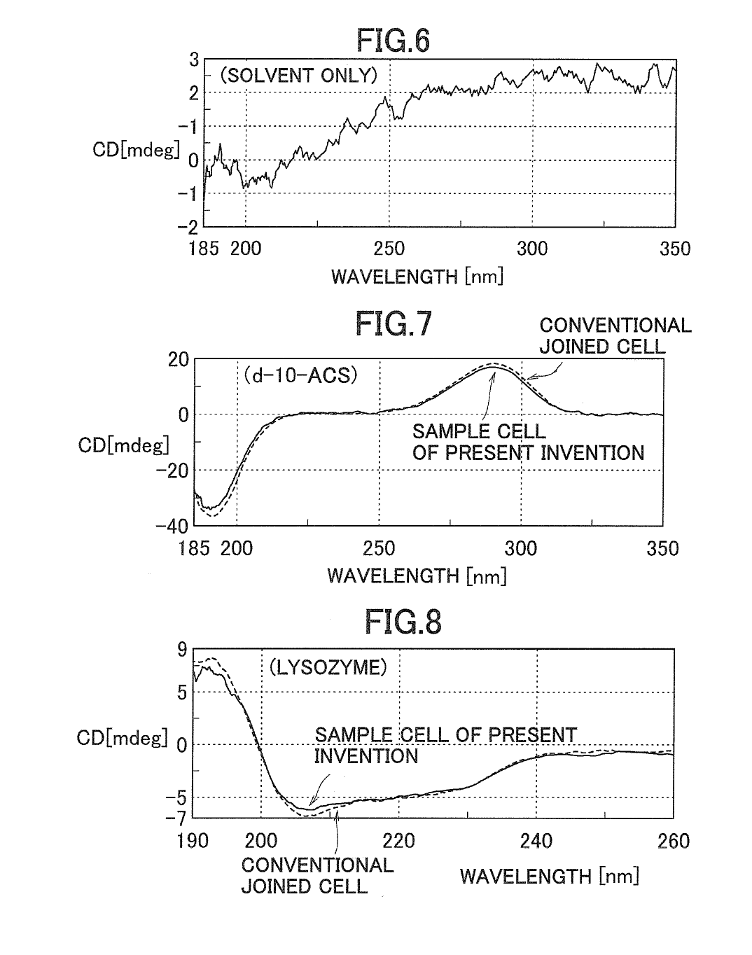

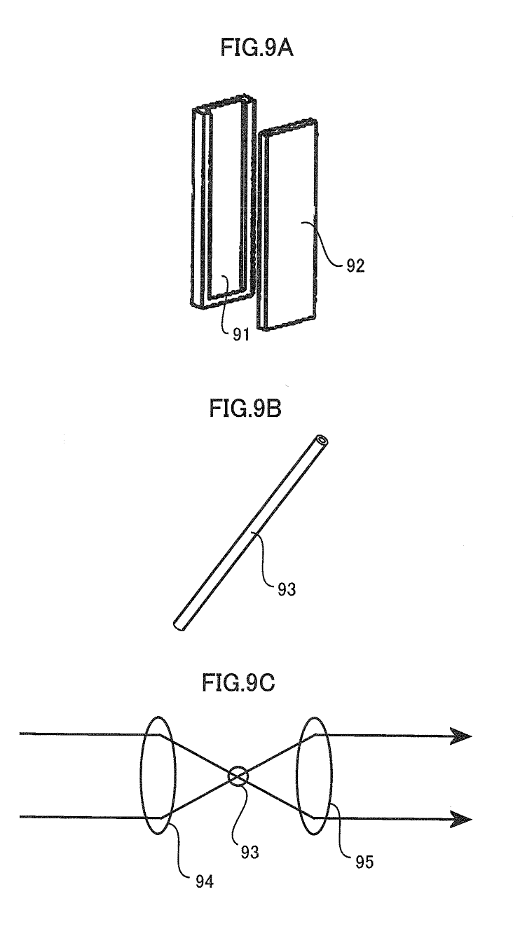

FIG. 6 shows the CD spectrum of the solvent. The horizontal axis indicates the wavelength of the radiated circularly polarized light, and the vertical axis indicates the magnitude of circular dichroism in terms of molar ellipticity. Since the solvent does not exhibit chirality, ideally the molar ellipticity is zero and the CD spectrum is flat. As the graph in FIG. 6 shows, when the sample cell 30 of the present invention was used, the baseline varied within the range of −1.4 to +2.9 mdeg (millidegrees) in the wavelength range of 185 to 350 nm (nanometers). The baseline did not show disturbance such as that caused by a strain in the conventional capillary cell. Therefore, with the use of the sample cell 30 of the present invention, a good baseline without distortion can be obtained.

FIG. 7 shows the CD spectrum obtained from a solution sample of d-form 10-camphorsulfonic acid ammonium salt (d-10-ACS). The concentration of the solution sample was 0.06% by weight, and the amount was 5 μl. The figure shows the results obtained by using the sample cell 30 of the present invention and the results obtained by using the conventional joined cell as a comparative example. Both results showed a negative peak at around 192 nm and a positive peak at around 290 nm, indicating a CD intensity ratio of 1:2, which is a normal value for circular dichroism.

The CD spectrum of 5 μl of 0.07 mg/ml lysozyme was also measured by using a phosphate buffer. As shown in FIG. 8, both the results obtained by using the sample cell 30 of the present invention and the results obtained by using the conventional joined cell showed a positive peak at around 190 nm, a negative peak at around 208 nm, and a shoulder at around 220 nm. These results indicate that the obtained CD spectra were correct.

Therefore, with the use of the sample cell 30 of the present invention, a correct CD spectrum can be obtained from a minute amount of solution sample, such as proteins and valuable natural extracts, ranging from a few microliters to ten microliters.

1. A solution sample holding method for measuring light passing through a minute amount of solution sample by holding the solution sample between two light-transmitting plate-like members facing each other with a predetermined distance between the plate-like members, the solution sample holding method comprising:
a dripping step of dripping a minute amount of solution sample in a drip area of a sample mounting face of a first light-transmitting member, the sample mounting face also including a liquid-repellent area surrounding the drip area; and
a covering step of covering the solution sample with a second light-transmitting member and maintaining a predetermined distance between the first light-transmitting member and the second light-transmitting member;
wherein the liquid-repellent area of the sample mounting face is covered with a liquid-repellent substance,
whereby the minute amount of solution sample is held in contact with the two light-transmitting members.

2. A sample cell for measuring light passing through a minute amount of solution sample, the sample cell comprising:
two light-transmitting plate-like members facing each other with a predetermined distance between the plate-like members;
wherein the first light-transmitting member has a sample mounting face containing a drip area where the solution sample is dripped and a liquid-repellent area surrounding the drip area, and the liquid-repellent area of the sample mounting face is covered with a liquid-repellent substance,
wherein the second light-transmitting member is kept at the predetermined distance from the first light-transmitting member and covers the solution sample dripped in the drip area of the sample mounting face,
whereby the solution sample is held between the two light-transmitting members in contact with the two light-transmitting members.

3. The sample cell according to claim 2, wherein the first light-transmitting member have indicating means for indicating, by color or unevenness, whether its front or back face is the sample mounting face.

4. A circular dichroism measuring apparatus for measuring the circular dichroism of a minute amount of solution sample, the circular dichroism measuring apparatus comprising:
the sample cell according to claim 2;
polarization modulating means for periodically modulating the polarization state of light emitted from light emitting means; and
detecting means for detecting light;
whereby polarization-modulated light is radiated onto the minute amount of solution sample through the first or second light-transmitting member of the sample cell; and light passing through the solution sample is detected by the detecting means.

5. A circular dichroism measuring apparatus for measuring the circular dichroism of a minute amount of solution sample, the circular dichroism measuring apparatus comprising:
the sample cell according to claim 3;
polarization modulating means for periodically modulating the polarization state of light emitted from light emitting means; and
detecting means for detecting light;
whereby polarization-modulated light is radiated onto the minute amount of solution sample through the first or second light-transmitting member of the sample cell; and light passing through the solution sample is detected by the detecting means
